(19) United States
(12) Patent Application Publication
(10) Pub. No.: US 2004/0168437 A1
(43) Pub. Date: Sep. 2, 2004

(54) Vapor over liquid diaphragm engine

(76) Inventor: Anwar Ul Haq, Corona, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/376,553

(22) Filed: Feb. 27, 2003

(51) Int. Cl. F01B 1/00; B60K 16/00; B60L 8/00; F03G 6/00; F02B 1/00; F01K 1/00

(52) U.S. Cl. 60/508; 60/641.8

(57) ABSTRACT

An engine comprising an enclosure having an open top surface and an interior volume partially filled with a fluid in both vapor and liquid phase and a biased diaphragm covering the open top surface of the enclosure. The biased diaphragm is movable between a concave and a convex states, thereby enabling instantaneous changing of the interior volume between a first lesser volume and a second greater volume respectively. A thrust tube extends laterally from the enclosure providing fluid communication between the interior volume and an external body of the fluid. A heater causes the fluid in the enclosure to produce a greater volume of the vapor phase. A thermal sensor enables the fluid to be heated and cooled cyclically thereby causing inflow and outflow of the fluid driving a thruster or a turbine.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to engines used for propulsion and for generating electricity, and more particularly to such an engine wherein a biased diaphragm is used for producing useful work.

2. Description of Related Art

The following art defines the present state of this field:

Ishikawa, U.S. Pat. No. 6,446,611 teaches a pulsation type diaphragm pump which prevents back flow of a fuel and has reduced parts and assembly requirements. An intake valve disposed between an intake chamber and a pump chamber has an intake valve seat protruded to an inner portion of the pump chamber and an intake valve body formed by a portion of a pump diaphragm. The intake valve body opens and closes an intake valve seat port in cooperation with an intake seat surface in accordance with oscillation of the pump diaphragm. A discharge valve disposed between the pump chamber and a discharge chamber has a discharge valve seat protruded to an inner portion of the discharge chamber and a discharge valve body formed by a portion of a pulsator diaphragm. The discharge valve body opens and closes a discharge valve seat port in cooperation with a discharge seat surface in accordance with oscillation of the pulsator diaphragm.

Fukami, U.S. Pat. No. 6,435,844 teaches a diaphragm pump comprising a first diaphragm operated with a driving mechanism such as a crank mechanism, a second diaphragm disposed so as to form an air chamber between the first diaphragm and the second diaphragm, and a pump chamber formed by the second diaphragm and a casing or the like, wherein the a pressure in the air chamber is changed by operating the first diaphragm with the driving mechanism and the second diaphragm is deformed by a change of the pressure in the air chamber to perform a pump function.

Tai et al, U.S. Pat. No. 6,334,761 teaches a silicone rubber diaphragm pump utilizing a pair of MEMS Parylene check valves and a miniature solenoid plunger and actuator is comprised of a spacer sandwiched by a silicone rubber diaphragm on one side and a check valve support on the other. The check valves in the check valve support form the inlet and outlet to a pumping chamber defined between the check valve support and silicone rubber diaphragm. The pumping action has been demonstrated by driving the silicone diaphragm with the plunger using the solenoid type actuator to generate over and under pressures in the chamber. This forces the pumped medium into and out of the chamber, thus allowing the medium to be transported. Tubing or connectors affixed to the inlet and outlet ports of the check valve support structure allow for external fluidic access. The pump works with both gas and liquid.

Heimueller, et al, U.S. Pat. No. 6,327,960 teaches a diaphragm pump with a hydraulically driven diaphragm which runs in a wavy manner in the radial direction, the arrangement is such that the wavelength and/or the amplitude of the wavy formation of the diaphragm is made variable in the radial direction.

The prior art teaches diaphragm pumps of many types and designs but does not teach a thermally actuated pump adapted for open thrust or for generating electrical energy. The present invention fulfills these needs and provides further related advantages as described in the following summary.

### SUMMARY OF THE INVENTION

The present invention teaches certain benefits in construction and use which give rise to the objectives described below.

An engine comprises an enclosure having an open top surface and an interior volume filled with a fluid in both vapor and liquid phase and a biased diaphragm covering the open top surface of the enclosure. The biased diaphragm is movable between a concave and a convex states by slight changes in vapor pressure of the vapor phase, thereby enabling instantaneous changing of the interior volume between a first lesser volume and a second greater volume respectively. A thrust tube extends laterally from the enclosure providing fluid communication between the interior volume and an external body of fluid; in one case a buoyant fluid, and in another case, a working fluid reservoir. A heater causes the fluid in the enclosure to produce a rising pressure in the vapor phase of the operating fluid. A thermal sensor enables the fluid to be heated and cooled cyclically thereby causing inflow and outflow of the fluid driving a propulsive thruster or a turbine.

A primary objective of the present invention is to provide an apparatus and method of use of such apparatus that provides advantages not taught by the prior art.

Another objective is to provide such an invention capable of providing thrust.

A further objective is to provide such an invention capable of providing electrical generation.

A still further objective is to provide such an invention capable of using solar radiation to operate.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a sectional schematic view of a first preferred embodiment of the invention showing a suction stroke of the engine as devised for propulsion;

FIG. 2 is a sectional schematic view thereof showing an expulsion stroke of the engine;

FIG. 3 is a sectional schematic view of a second preferred embodiment of the invention showing a suction stroke of the engine as devised for power generation;

FIG. 4 is a sectional schematic view thereof showing an expulsion stroke of the engine; and

FIG. 5 is an electrical schematic diagram thereof.

### DETAILED DESCRIPTION OF THE INVENTION

The above described drawing figures illustrate the invention in at least one of its preferred embodiments, which is further defined in detail in the following description.

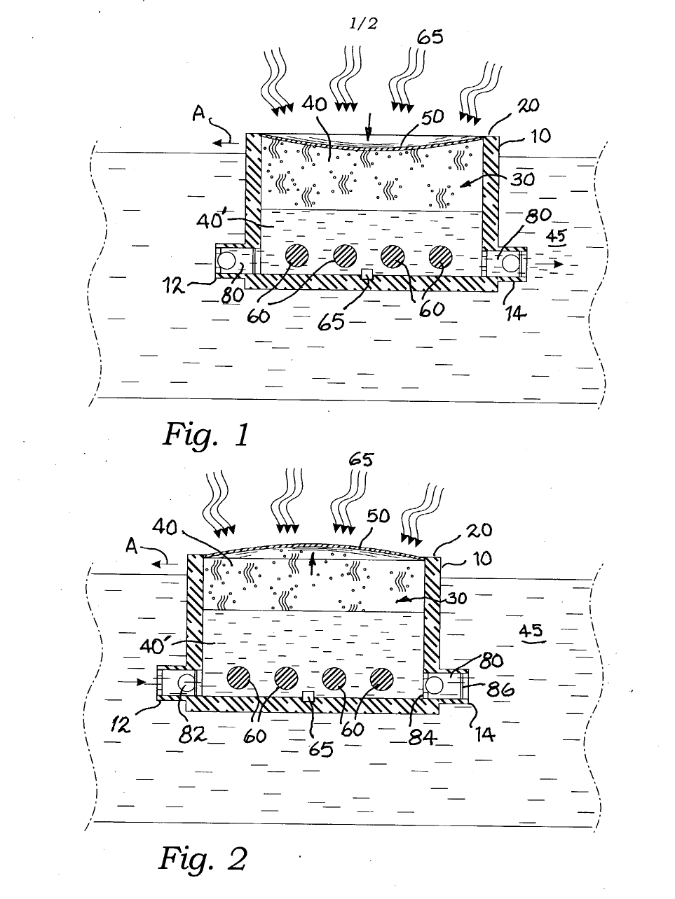

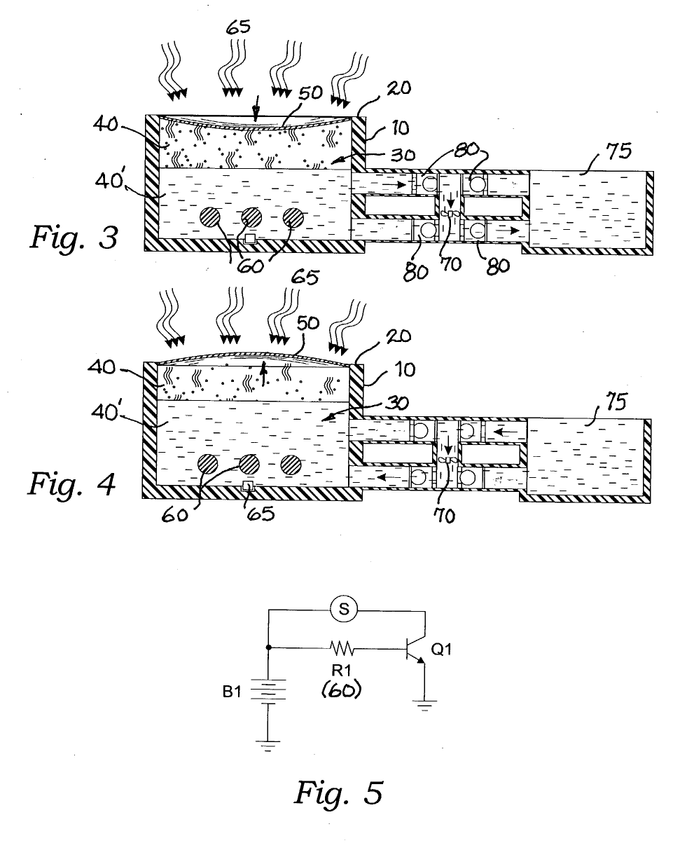

The present invention is an engine apparatus useful for producing thrust and for driving a turbine. The engine comprises an enclosure 10 having an open top surface 20 and an interior volume 30 filled with a fluid in both vapor 40 and liquid 40′ phases, that is, the vapor phase 40 exists over the liquid phase 40′ and the temperature of the liquid phase 40′ determines the pressure within the vapor phase 40. To accomplish this dynamically, the liquid phase 40′ may be held to fluctuate about its boiling point moving to above boiling and to below boiling by very small degrees. A biased diaphragm 50 is engaged with, and covers the open top surface 20, being attached to the surface 20 in any manner wherein the diaphragm 50 is sealed to the surface 20. The biased diaphragm 50 is formed as a spring having two stable states, i.e., is movable between one of a concave (FIGS. 1 and 3) and a convex (FIG. 2 and 4) attitudes or states and changes state at a selected change in pressure across it, thereby enabling instantaneous changing of the interior volume 30 between a first lesser volume and a second greater volume respectively. The amount of pressure differential across the diaphragm 50, that is required to move the diaphragm 50 between these two rest states is preferably made to be small so that the diaphragm 50 is ready to move to its alternate state quite easily. Clearly, the surface 20 may be complex with plural diaphragms 50, or with larger or smaller diaphragms 50, but in any configuration, the operation of the diaphragms, singular or plural, is the same. The preparation of a device such as diaphragm 50 is well known in the art and is in common use as a spring in many industrial instruments such a valves, flow and pressure sensors and such.

In one embodiment of the invention, the engine provides thrust for mobility of the engine through a buoyant fluid 45 and may therefore be used to propel a water craft (not shown). As seen in FIGS. 1 and 2, a pair of thrust tubes 12, 14 extend laterally and in opposing directions from the enclosure 10 along the line of movement of the enclosure 10 through the buoyant fluid as shown by small arrows “A”. The buoyant fluid 45 is typically water. The operating fluid 40, 40′ within the enclosure 10 is able to communicate with the buoyant fluid 45 which supports the enclosure 10. A means for heating 60 of the operating fluid, such as an immersion resistance heater R1 (FIG. 5) provides very fast heating to the operating fluid and can cause almost instantaneous temperature changes within the operating fluid including its vapor phase 40. The heating means 60 may also be solar energy 65 incident on the diaphragm 50, but, obviously, such an embodiment is much less controllable. When the liquid phase 40′ of the operating fluid is heated, the pressure in its vapor phase 40 increases enough to cause the diaphragm 50 to move from concave to convex, as shown in FIGS. 2 and this causes suction of fluid from the buoyant fluid 45 into the enclosure 10 through thrust tube 12 and movement of the apparatus in the direction of arrow “A”. With inrushing buoyant fluid 45 comes cooling of the operating fluid 40′ and reduction of the pressure of its vapor phase 40, which, in turn, causes movement of the diaphragm 50 from the convex to the concave state (FIG. 1). This causes the expelling of operating fluid 40′ from the enclosure 10 through thrust tube 14 and furtherer movement of the apparatus in the direction of arrow “A”. This cycle is repeated continuously and may occur in rapid succession to produce considerable thrust and propulsive force.

In an alternate stationary embodiment the inflow and outflow of operating fluid 40 may be directed to a turbine 70 to generate electricity, or do other useful work, as shown in FIGS. 3 and 4. The turbine 70 is configured to rotate in only one direction for both operating fluid outflow shown in FIG. 3, as well as inflow shown in FIG. 4. A separate fluid reservoir 75 is used to provide a source and sink for the operating fluid 40 as it moves through the turbine 70. In controlling of the fluid flows, check valves 80 are employed, as are well known in industry. The check valves 80 allow fluid flow in only one direction and usually are constructed with a ball 82 that moves with fluid flow between a valve seat 84, preventing flow, and a screen 86, allowing flow.

To accomplish the above operating results, the apparatus further comprises an electrical circuit, shown in FIG. 5, including the resistance heater R1 (60), a source of electrical energy such as a battery B1, or utility current, a temperature sensor 65 such as a thermister or thermocouple, and an electrical switch such as a high current transistor Q1 or similar device. The temperature sensor 65 is in contact with the liquid phase 40′ of the operating fluid in the enclosure 10 and is interconnected in the circuit for actuating the resistance heater R1 at a selected low temperature of the liquid phase 40′, and for de-actuating the resistance heater R1 at a selected high temperature of the liquid phase 40′. It should be clear that the turbine may produce the electrical energy to operate the electrical circuit including charging the battery B1. In this, therefore, the engine may be operated without external energy input in a closed cycle.

The method of operating the apparatus comprises the steps of filling the enclosure 10 with the operating fluid 40, 40′ in both vapor and liquid phase; sealing the enclosure 10 with the biased diaphragm 50; providing the thrust tube or tubes 12, 14; providing the means for heating 60 the fluid in the enclosure 10; switching the heating means 60 on when the temperature in the fluid 40′ is below a selected temperature thereby raising the vapor pressure in the vapor phase 40 of the fluid; moving the diaphragm 50 to the convex state when the vapor pressure is increased thereby sucking operating fluid 40, into the enclosure and thus cooling the operating fluid in the enclosure 10 and reducing the vapor pressure; and moving the diaphragm 50 to the concave state thereby driving fluid 40′ out of the enclosure 10 due to the reduced vapor pressure; and repeating this process cyclically.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An engine apparatus comprising: an enclosure having an interior volume partially filled with a fluid in both vapor and liquid phase; a biased diaphragm functions as one wall of the enclosure and is movable between one of a concave and a convex states, thereby enabling instantaneous changing of the interior volume between a first lesser volume and a second greater volume respectively; a thrust tube extending laterally from the enclosure providing fluid communication between the interior volume and an external fluid body of the fluid; and a means for heating the fluid in the enclosure cyclically to cause fluctuation of the diaphragm between the concave and convex states.

2. The apparatus of claim 1 wherein the heating means is solar energy incident on the diaphragm.

3. The apparatus of claim 1 wherein the heating means is a resistance heater within the liquid phase of the fluid within the enclosure.

4. The apparatus of claim 3 further comprising an electrical circuit comprising the resistance heater, a source of electrical energy, a pressure sensor and an electrical switch, the pressure sensor in contact with the liquid phase of the fluid in the enclosure and interconnected in the circuit for actuating the resistance heater at a selected high low temperature of the liquid phase, and for de-actuating the resistance heater at a selected high temperature of the liquid phase.

5. A method of operating an engine comprising the steps of: filling an enclosure with a fluid in both vapor and liquid phase; sealing the enclosure with a biased diaphragm, the biased diaphragm movable between one of a concave and a convex states, thereby enabling instantaneous changing of the interior volume of the enclosure between a first lesser volume and a second greater volume respectively; providing a thrust tube extending from the enclosure and providing fluid communication between the interior volume and an external fluid body; providing a means for heating the fluid in the enclosure; switching the heating means on when the temperature in the fluid is below a selected temperature thereby raising the vapor pressure in the vapor phase of the fluid; moving the diaphragm to the convex state when the vapor pressure is increased thereby sucking fluid into the enclosure thereby cooling the fluid in the enclosure and reducing the vapor pressure; moving the diaphragm to the concave state thereby driving fluid out of the enclosure when the vapor pressure is reduced; and repeating the change of the diaphragm from concave to convex cyclically.
